(19) United States
(12) Patent Application Publication
(10) Pub. No.: US 2004/0039590 A1
(43) Pub. Date: Feb. 26, 2004

(54) Freight forwarding security system for air cargo

(76) Inventors: Alan J. Meehan, Prior Lake, MN (US); Robert Masters, Prior Lake, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/445,369

(22) Filed: May 22, 2003

Related U.S. Application Data
(60) Provisional application No. 60/382,531, filed on May 22, 2002.

(51) Int. Cl. G06F 17/60

(52) U.S. Cl. 705/1

(57) ABSTRACT

A method and a system for security screening containers at a freight consolidation location, prior to delivery of the containers to a carrier.

### BACKGROUND OF THE INVENTION

Currently, there is a need for increased security screening of freight before loading it on a carrier.

### SUMMARY OF THE INVENTION

The present invention provides a method and a system for security screening freight at a freight consolidation location, prior to delivery of the freight to the carrier.

### BRIEF DESCRIPTION OF THE DRAWINGS

FIG. 1 is a block diagram of the cargo screening system;

FIG. 2 is a pictorial view of a tracking label;

FIG. 3 is a flow diagram of a shipper entry process;

FIG. 4 is a pictorial view of an air waybill;

FIG. 5 is a flow diagram of the cargo screening process;

FIG. 6 is a flow diagram of a heightened security screening process; and

FIG. 7 is a flow diagram of the portions of the screening process carried out by a carrier.

### DETAILED DESCRIPTION

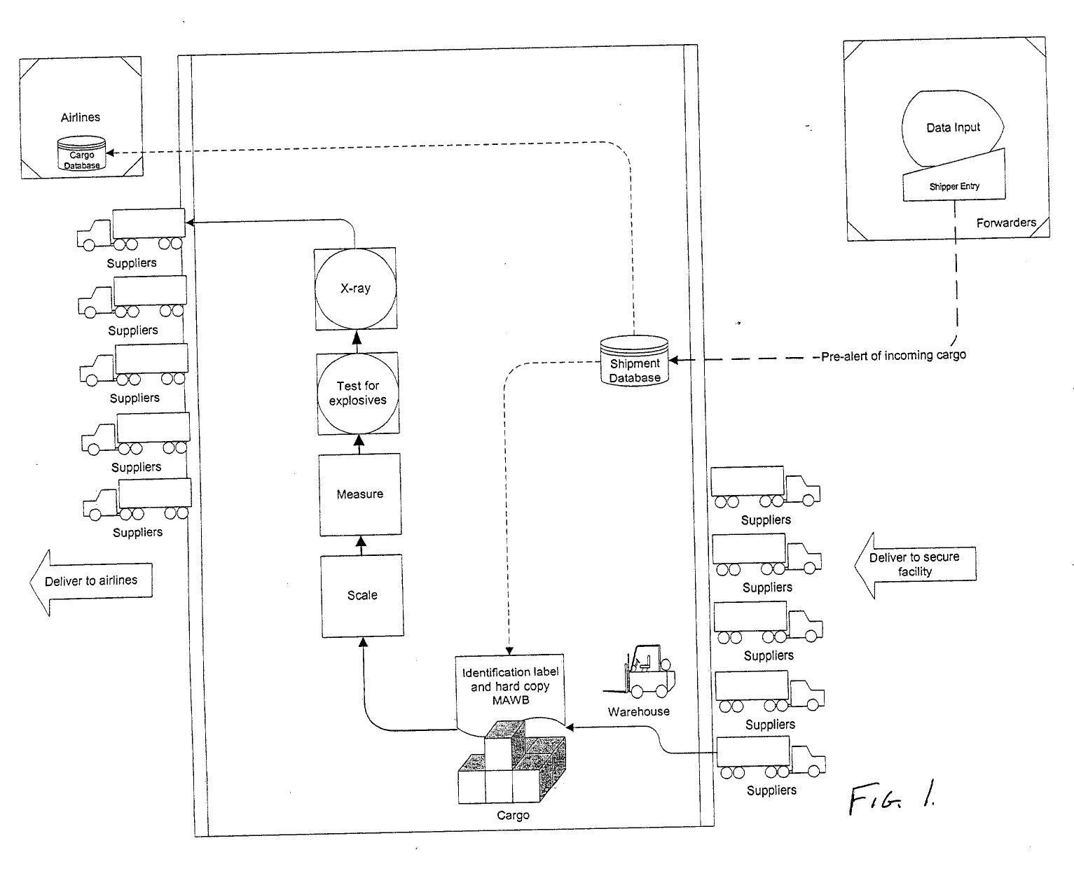

FIG. 1 is a block diagram of an embodiment of the invention.

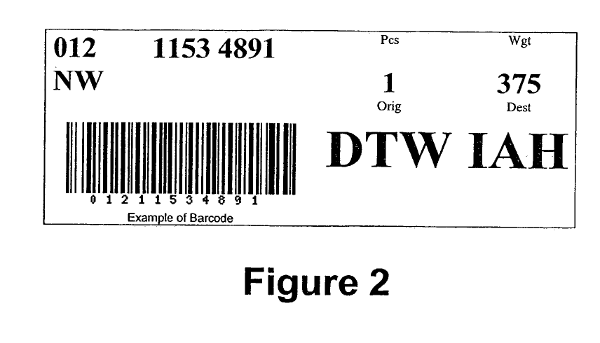

FIG. 2 is a pictorial view of an embodiment of a tracking label.

I. Shipper Entry Process

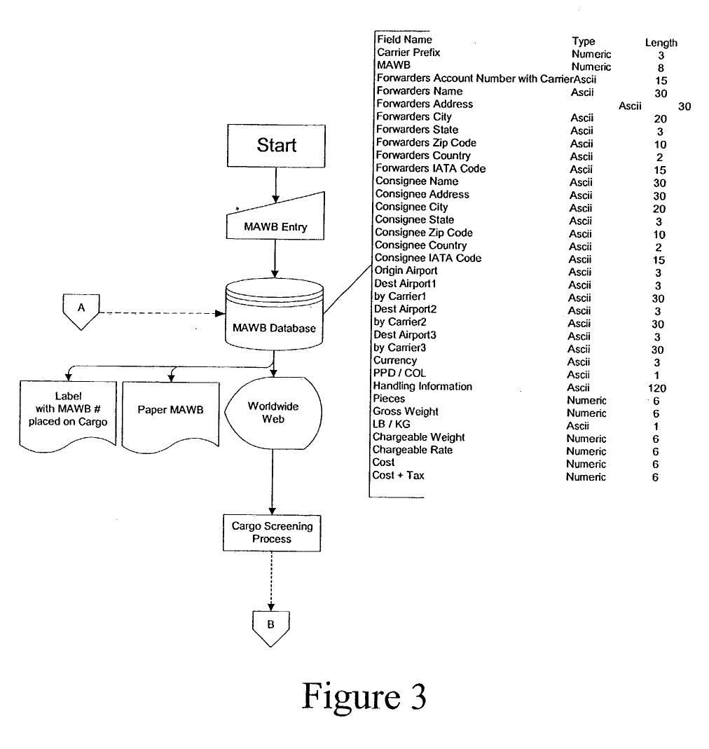

The flow diagram for the shipper entry process according to an embodiment of the invention is shown in FIG. 3.

Master Air Waybill (MAWB) Entry:

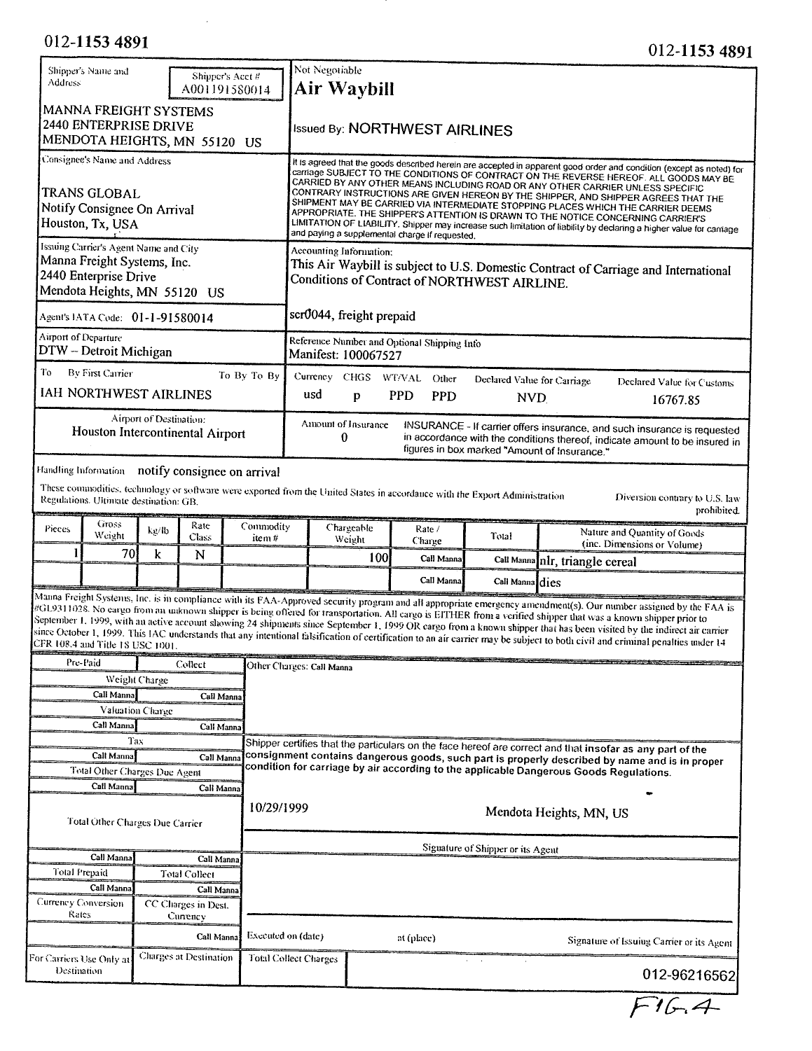

Using a Web-based ASP process, the shipper will enter pertinent information to create an airline MAWB. An embodiment of a waybill is shown in FIG. 4.

MAWB Database:

Upon submission to the database, the MAWB detail will be available to the security facility.

The fields as shown in Table 1 may be used for the MAWB entry.

TABLE 1

| | Field Name | Type | Length |
|---|---|---|---|
| | Carrier Prefix | Numeric | 3 |
| | MAWB | Numeric | 8 |
| | Forwarders Account | | |
| | Number with Carrier | Ascii | 15 |
| | Forwarders Name | Ascii | 30 |
| {open oversize brace} | | | |
| | Forwarders Address | Ascii | 30 |
| | Forwarders City | Ascii | 20 |
| | Forwarders State | Ascii | 3 |
| | Forwarders Zip Code | Ascii | 10 |
| | Forwarders Country | Ascii | 2 |
| | Forwarders LATA Code | Ascii | 15 |
| | Consignee Nae | Ascii | 30 |
| | Consignee Address | Ascii | 30 |
| | Consignee City | Ascii | 20 |
| | Consignee State | Ascii | 3 |
| | Consignee Zip Code | Ascii | 10 |
| | Consignee Country | Ascii | 2 |
| | Consignee IATA Code | Ascii | 15 |
| | Origin Airport | Ascii | 3 |
| | Dest Airport1 | Ascii | 3 |
| | by Carrier1 | Ascii | 30 |
| | Dest Airport2 | Ascii | 3 |
| | by Carrier2 | Ascii | 30 |
| | Dest Airport3 | Ascii | 3 |
| | by Carrier3 | Ascii | 30 |
| | Currency | Ascii | 3 |
| | PPD/COL | Ascii | 1 |
| | | | 12 |
| | Handling Information | Ascii | 0 |
| | Pieces | Numeric | 6 |
| | Gross Weight | Numeric | 6 |
| | LB/KG | Ascii | 1 |
| | Chargeable Weight | Numeric | 6 |
| | Chargeable Rate | Numeric | 6 |
| | Cost | Numeric | 6 |
| | Cost + Tax | Numeric | 6 |

The information in the brackets of Table 1, in one embodiment, may be subject to default entry from a data table accessed through the same Web interface.

Additionally, in one embodiment, a template may be available to the users allowing them to automatically perform the entry for the entire MAWB.

II. Tracking Label

The output, in one embodiment, may be a tracking label, per piece, which may include a bar code for scanning and may be placed on the pieces. FIG. 2 illustrates an embodiment of a tracking label.

Paper MAWB:

In one embodiment, a paper copy of the MAWB may also be produced for the airline.

Web Output:

This information, in one embodiment, may be made available on the Web so that the forwarder and carrier can have access at any time.

III. Cargo Screening Process

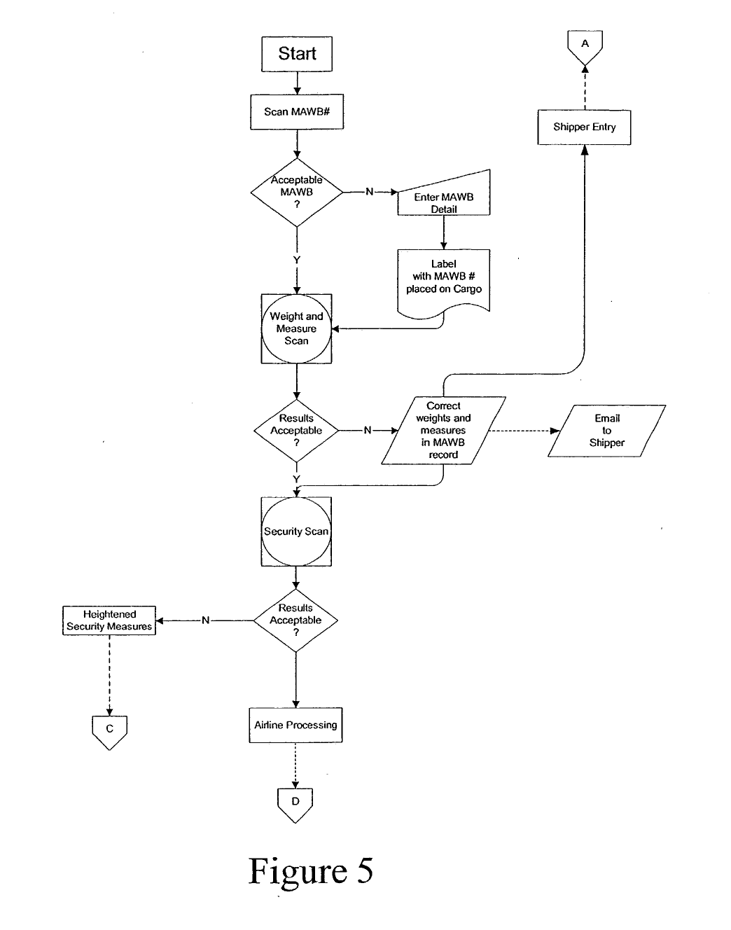

FIG. 5 is a flow diagram of an embodiment of the cargo screening process.

Scan MAWB#:

Using a standard handheld barcode scanner, the tracking number will be scanned and entered into the data table thereby denoting acceptance of the shipment.

Acceptable MAWB?:

If the label is not readable or if the shipper has not used the Web Entry System, then go to “Enter MAWB Detail” else, go to “Weight and Measure Scan”.

Enter MAWB Detail:

Open Web Entry System on terminal browser and perform entry as detailed in “Shipper Entry”.

Label Cargo:

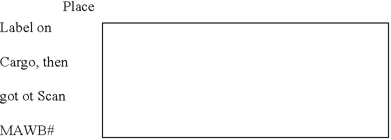

Weight and Measure Scan:

Freight will be placed on the conveyor system by a forklift and is systematically placed into a Laser Dimensioning system followed by an electronic scale. The data collected by these systems will be relayed to the MAWB database and compared with the previously entered data.

Results Acceptable?:

If the comparison indicates a change in weight or dimensions then go to “correct weights and measures in MAWB record”, else go to “Security Scan”.

Correct Weights and Measures in MAWB Record:

Overwrite the data produced by the laser dimensioning to the Chargeable Weight field of the MAWB data table and system and overwrite the data produced by the electronic scale to the data field labeled Gross Weight.

E-mail to Shipper:

E-mail weight change results to the shipper.

IV. Security Scan:

FIG. 5 is a flow diagram of an embodiment of a cargo screening process.

In one embodiment, this may be a two-stage process including both gas chromatograph and x-ray scanning technologies.

a. Explosives

The scan for explosives residue will be performed with the use of a briefcase-sized gas chromatograph it takes samples from the air to detect the presence of chemicals such as those used in bombs, explosives, and chemical weapons. This process will take between 10 and 90 seconds.

Results Acceptable?:

If the results are acceptable then go to X-ray else go to “Heightened Security Measures”

b. X-Ray

The scan for visible explosives will be performed with the use of an in-line, conveyor driven x-ray system, which will scan cargo and save images of the scan. This process will take approximately 60 seconds.

V. Physical Inspection

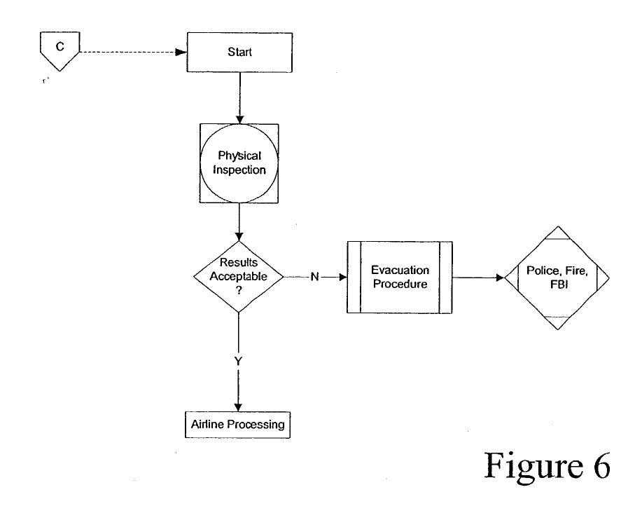

In the embodiment of an enhanced security process shown in the flow diagram of FIG. 6. a pallet of packages will be completely dismantled and all packages may be opened.

Results Acceptable?

If the results are acceptable then go to “Airline Processing”, else go to “Evacuation Procedure”

VI. Evacuation Procedure

Press button on nearest emergency alarm system and completely evacuate the building,

VII. Airline Processing:

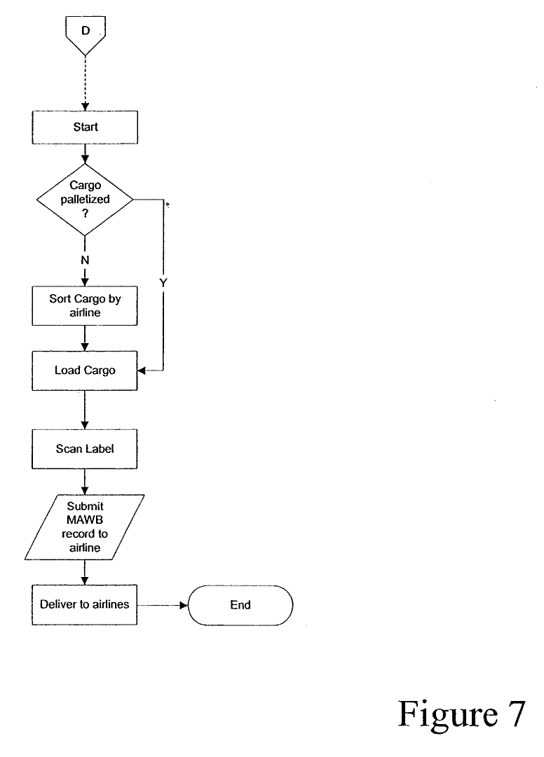

A flow chart for the carrier, which in one embodiment may be an airline, is shown in FIG. 7.

Cargo Palletized?

If the cargo is palletized then go to “Load Cargo”, else go to “Sort Cargo by Airline”.

Sort Cargo By Airline:

Remove cargo from end of conveyor belt with lift truck and place in staging area with automated sorters. Sorters will read barcode and determine which airline is to receive the shipment. The shipments will be palletized, then go to “Load Cargo”.

Load Cargo:

Load cargo into the truck designated by label.

Scan Label:

Scan label with barcode scanner to indicate that cargo is loaded onto delivery truck.

Submit MAWB Record to Airline:

MAWB will be electronically submitted to airlines through various Value Added Networks, which service the electronic communications needs of the airlines.

Deliver to Airlines:

Seal the trailer and deliver directly to the designated airline.

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

What is claimed is:

1. A method, comprising
receiving packages from at least one shipper at a freight consolidation location, each of the packages bearing a waybill applied by the shipper, each waybill bearing package specific information;
entering information from the waybill of each package into a master database;
verifying at least one portion of the package specific information at the freight consolidation location and updating the master database to conform to the package specific information determined at the freight consolidation location; and
conducting security screening procedures at the freight consolidation location on at least one of the packages.

2. The method of claim 1, wherein verifying package specific information comprises weighing at least one package.

3. The method of claim 1, wherein verifying package specific information comprises measuring at least one dimension of at least one package.

4. The method of claim 1, wherein updated package specific information determined at the freight consolidation station is communicated to the shipper.

5. The method of claim 4, wherein the communication of package specific information to the shipper comprises sending an e-mail communication to shipper.

6. The method of claim 4, wherein the communication of package specific information to the shipper comprises communicating the package specific information over the Internet to a shipper database.

7. The method of claim 1, wherein information from the master database is communicated over the Internet to a database of the carrier which is to receive packages sorted for that carrier.

8. The method of claim 1, wherein conducting security screening procedures comprises verifying the safety of the contents of at least one of the packages using chromatographic measurements.

9. The method of claim 1, wherein conducting security screening procedures comprises examining the contents of at least one of the packages using x-ray.

10. The method of claim 1 wherein sorting packages for a carrier also comprises transporting sorted packages to the carrier.

11. The method of claim A-10 wherein transporting packages to the carrier also comprises placing the packages for a carrier on at least one pallet for that carrier.

12. The method of claim 1 also comprising sorting packages for a carrier based on the waybill information.

13. A security screening system for screening packages received at a freight consolidation location from a plurality of shippers for shipment by a plurality of carriers comprising:
scanning apparatus for scanning each of the packages for a waybill applied by the shipper, each waybill bearing package specific information;
a data entry module for entering information from the waybill of each package into a master database;
measurement apparatus for verifying at least one portion of the package specific information at the freight consolidation location and also comprising input apparatus for updating the master database to conform to the package specific information scanned at the freight consolidation location; and
security screening apparatus for conducting security screening procedures on at least one of the packages at the freight consolidation location.
